(19) United States
(12) Patent Application Publication
(10) Pub. No.: US 2017/0332619 A1
(43) Pub. Date: Nov. 23, 2017

(54) SCENTED THROWING DART

(71) Applicant: Steven P. Cummins, Mogadore, OH (US)

(72) Inventor: Steven P. Cummins, Mogadore, OH (US)

(21) Appl. No.: 15/495,402

(22) Filed: Apr. 24, 2017

Related U.S. Application Data
(60) Provisional application No. 62/338,053, filed on May 18, 2016.

(51) Int. Cl. A01M 31/00; F42B 12/50; F42B 12/36

(52) U.S. Cl. CPC A01M 31/008; F42B 12/362; F42B 12/50

(57) ABSTRACT

An improved method, device, and system for hunting and selectively placing a scented hunting aid is provided. A hand-thrown dart may have a tip and a flight attached opposite thereto. The flight may carry a scented fluid or scented material thereon. The flight is configured to be positioned above the ground after the dart has been thrown by hunter from a tree stand. The dart enables the hunter to selectively throw the dart such that its placement is upwind from a desired game animal such as a buck deer that the hunter desires to attract. Some implementations utilize peelable covers to release the scented material, while other embodiments utilize a porous or sponge-like flight that is saturated with a scented fluid.

### CROSS REFERENCE TO RELATED APPLICATIONS

This application claims the benefit of prior co-pending U.S. Provisional Application Ser. No. 62/338,053, filed on May 18, 2016; the disclosure of which is entirely incorporated herein by reference.

### BACKGROUND

### Technical Field

The present disclosure relates generally to a hunting aide. More particularly, the present disclosure relates to a device that selectively places and releases a scent in a desired position enabling the scent to be carried downwind. Specifically, the present disclosure relates to a hand thrown dart having scented flights that stick up from the ground after being thrown from a tree stand in order to attract an animal.

### Background Information

Animals often use scents, such as urine, to mark territory or indicate to an opposite gender that the animal is ready to mate. When an animal releases a scent, such as urine, its odors may be carried by the wind for many miles. Animals have adapted to sense and detect (i.e., to smell) these various scents in the wild. In the scenario of a first male animal marking its territory, a competing dominant animal, such as a rival second male, may become aware of the first male's territory and decide to challenge the first male in order to take over the territory. In the scenario where a female animal indicates it is ready to mate, a male animal may detect the scent and be drawn towards the female who is in heat.

Hunting aides utilized by hunters often take advantage of these natural and biological urges of the animal. For example, when hunting for buck (male) deer, a hunter may utilize doe (female) deer urine in order to attract the male deer by deceiving the male into thinking that a female deer is nearby. When the male deer is sufficiently close to the hunter, the hunter may kill the deer with their weapon as one having ordinary skill in the art would understand.

Typically, doe urine is provided in a fluid form in a jar with a medicine dropper. The doe urine is easy to accidentally mishandle and requires the hunter to place drops of urine on the ground upwind from the potential downwind direction and then climb into a tree stand where the hunter sits and waits for the deer.

Others have attempted to provide a scent on an arrow that may be shot from a bow. For example, U.S. Pat. No. 5,035,435 (the '435 patent) discloses a hunting scent dispersing device for attachment to the shaft of an arrow. The dispersing device includes an absorbent carrier for retaining and permitting release therefrom of a hunting scent which is to be releasably attached to the arrow. The '435 patent clearly shows a scented patch that is positioned forwardly from the flights on the rear end of the arrow. Furthermore, the arrow is substantially uniform in diameter along the length of the arrow shaft and would be weight balanced as required by arrows. The arrow of the '435 patent has nocks or a notch at the rear end of the arrow to indicate that it is to be shot by the bow. It is recognized that the '435 patent indicates that its disclosure can be of utility with elongated projectiles other than arrows. The '435 patent provides an example of a rigid projectile such as a steel, wood, or fiberglass rod having a sharpened point end that could be used as a carrier. In this scenario, the '435 patent indicates that a rifle hunter not having a desire to carry a bow and arrow could simply throw the steel rod with the carrier attached to an end thereof opposite the pointed end so as to imbed the point end of the projectile with the carrier attached thereto at a desired distance from their position. The '435 patent indicates that the rod would need to be weighted to compensate for the lower velocity of a manually thrown projectile as compared to that of an arrow or other projectile shot from a bow or slingshot.

### SUMMARY

Issues continue to exist with current known devices and methods for placing a scent to attract a game animal. For example, as indicated above, current methods for placing doe urine require the hunter to place the urine on the ground prior to entering the tree stand. This is problematic as the wind direction may shift and move while the hunter is in the stand. This hurts the hunter's chances of attracting a male deer because the wind may shift in a direction which can carry the hunter's scent downwind to the deer and scare the deer off or may simply carry the doe urine scent in a different direction such that it is not observed by the male deer and he will not be attracted thereto. Additionally, with respect to the '435 patent, it indicates that the carrier is distinct and different from the flights or fletching positioned forwardly from the knock in the arrow. Thus, the '435 patent falls short from showing that the flights of a dart can be integrally formed with a scent or that maybe formed of a material that contain an odorant liquid or otherwise scented liquid. Thus, a need continues to exist for improved devices and methods for attracting wild game such as a buck deer. The present disclosure addresses these and other issues.

In accordance with one aspect of the present disclosure, an embodiment may provide a hand-thrown dart that enables the hunter to selectively throw the dart to a position after the hunter has already entered the tree stand. When the hunter is in the tree stand, they have a better judgement for determining wind direction and a desired placement of the dart in order to release the scented material carried by the rear end or flight on the dart. Additionally, the dart of the present disclosure provides an advantage over previous methods of being able to throw a second dart after the wind has changed directions. This is advantageous in that when a second dart is thrown, the hunter can still selectively place the scent in an upwind direction from the deer without climbing down from the tree stand. It should be readily apparent to any hunter that climbing in and out of a tree stand causes significant noise which is likely to scare away a buck deer they are trying to attract during a hunt.

In accordance with another aspect, an embodiment of the present disclosure may provide a scented throwing dart used as a hunting aide comprising: a tip; a barrel connected to the tip; a shaft connected to the barrel opposite the tip; and a flight connected to the shaft carrying scented material configured to attract a game animal such as a buck deer; wherein the dart is adapted to be thrown from a tree stand by a hunter in order for the scent to be carried downwind to attract the game animal from a specific direction.

In accordance with another aspect, an embodiment of the present disclosure may provide an improved method, device, and system for hunting and selectively placing a scented hunting aide. A hand-thrown dart may have a tip and a flight attached opposite thereto. The flight may carry a scented fluid or scented material thereon. The flight is configured to be positioned above the ground after the dart has been thrown by hunter from a tree stand. The dart enables the hunter to selectively throw the dart such that its placement is upwind from a desired game animal such as a buck deer that the hunter desires to attract. Some implementations utilize peelable covers to release the scented material, while other embodiments utilize a porous or sponge-like flight that is saturated with a scented fluid.

In accordance with another aspect, an embodiment of the present disclosure may provide a tip on a dart is a substantially elongated cylindrical member having a sharpened tip but is a generally uniform diameter along its length and does not contain any barbs. The barrel of the dart may have a diameter that is larger than the tip. Stated otherwise, the largest diameter of the dart is at the midsection along its longitudinal length such that the center portion is wider or has a larger diameter than the tip, as opposed to a conventional arrow which has barbs that are typically the widest portion of the tip. Furthermore, arrows are typically weight balanced whereas the present disclosure may provide provides a forward weighted dart because to stick into the ground such that the tail end is pointed up. Furthermore, the flight carrying the scent may define the rear end of the dart and such that that nothing is rearward of/behind the flights.

In accordance with one aspect, an embodiment of the present disclosure may provide a scented throwing dart used as a hunting aide comprising: a tip; a barrel connected to the tip; and a flight that carries a scent and configured to attract a game animal; wherein the throwing dart is adapted to be manually thrown from a tree stand by a hunter in order for the scent to be carried downwind to attract the game animal from a remote location towards the hunter in the tree stand. This embodiment or another may provide a shaft connected to the barrel opposite the tip, wherein the shaft defines a slot in a rear end that slidably receives the flight. This embodiment or another may provide wherein the scent is at least partially rearward from the slot. This embodiment or another may provide wherein the flight is formed from a uniform polymer material having the scent integrally formed therein. This embodiment or another may provide wherein the flight is formed from a solid material carrying a scented patch having a selectively peelable cover configured to selectively release the scent when the cover has been peeled. This embodiment or another may provide wherein the flight is formed from a porous material configured to hold the scent in fluid form. This embodiment or another may provide a slip cover covering the flight, wherein the scent is carried by the slip cover. This embodiment or another may provide wherein the slip cover has a cross section shape complementary to the flight to effectuate a slidable mating relationship therebetween. This embodiment or another may provide a first diameter of the tip; a second diameter of the barrel, wherein the second diameter is larger than the first diameter; and a ratio of the second diameter to the first diameter that is in a range from about 7:5 to about 20:1. This embodiment or another may provide a first length of the tip; a second length of the barrel; a ratio of the second length to the first length that is in a range from about 0.5:1 to about 2:1.

In another aspect, an embodiment of the present disclosure may provide a method of attracting a game animal to be hunted comprising: providing a dart for use as a hunting aide that is sized and shaped to be hand thrown comprising an animal attracting scent or odor carried by a flight defining a tail end of the dart rearward from a shaft; and hand throwing the dart into a ground surface so at to establish the dart in-ground position wherein a tip is embedded in the ground and the flight sticks upwardly above the ground. This embodiment or another may provide wherein step of hand throwing the dart is accomplished by throwing the dart from an elevated position towards the ground. This embodiment or another may provide placing scent near the ground adapted to enable a hunter to remain in a tree stand without interrupting the scent effectuating attraction of an animal towards the flight. This embodiment or another may provide wherein hand throwing the dart is accomplished by grasping a barrel of the dart having a diameter larger than a tip of the dart, wherein a ratio of barrel diameter to tip diameter is in a range from about 7:5 to about 20:1. This embodiment or another may provide peeling a releasably cover away from the flight to expose the scent. This embodiment or another may provide dipping the flight into scented fluid, wherein the flight is porous configured to absorb and carry the scented fluid as the dart is hand thrown. This embodiment or another may provide adding scented fluid to the flight, wherein the flight are porous configured to absorb and carry the scented fluid as the dart is hand thrown. This embodiment or another may provide breaking a vial containing the scented fluid and effecting fluid transfer from the vial to the porous flight. This embodiment or another may provide wherein the flight is fabricated from a uniform polymer material integrally formed with the scent or odor.

It is believed that the present disclosure could be classified under the cooperative patent classification (CPC Scheme) in F42BE12/362 or F42B6/04, which generally pertain to darts for dispensing materials, for producing chemical or physical reaction, or for signaling, however this belief is not intended to be limiting, and another CPC Scheme is possible.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of a first embodiment dart having a scented material thereon.

FIG. 2 is an enlarged side elevation view of the first embodiment dart depicting a flight having scented material covered by a removable cover.

FIG. 3 is a side elevation view of a second embodiment dart in accordance with the present disclosure having a porous or sponge-like flight.

FIG. 4 is an enlarged side elevation view of the flight of the second embodiment having scented fluid dropped thereon and absorbed therein.

FIG. 5 is a side elevation view of a third embodiment dart in accordance with the present disclosure having a porous and fluid absorbing flight and a vial of scented fluid contained in a shaft of the dart.

FIG. 6 is a second end view of the third embodiment dart taken along line 6-6 in FIG. 5.

FIG. 7 is a cross section view of the third embodiment dart taken along line 7-7 in FIG. 6.

FIG. 8 is a cross section view depicting the operation of the third embodiment dart taken along line 7-7 in FIG. 6.

FIG. 9 is a side elevation view of a fourth embodiment dart having flights formed of a plastic material carrying a scent integrally formed therewith.

FIG. 10 is a perspective view of a slip cover configured to retain scented fluid.

FIG. 11 is an enlarged side elevation view depicting the operation of the slip cover being fitted onto a conventional flight of a conventional dart which collectively define a fifth embodiment of the present disclosure.

FIG. 12 is an operational view of the dart within an environmental setting depicting a hunter in a tree stand utilizing the dart of the present disclosure to attract a deer.

Similar numbers refer to similar parts throughout the drawings.

### DETAILED DESCRIPTION

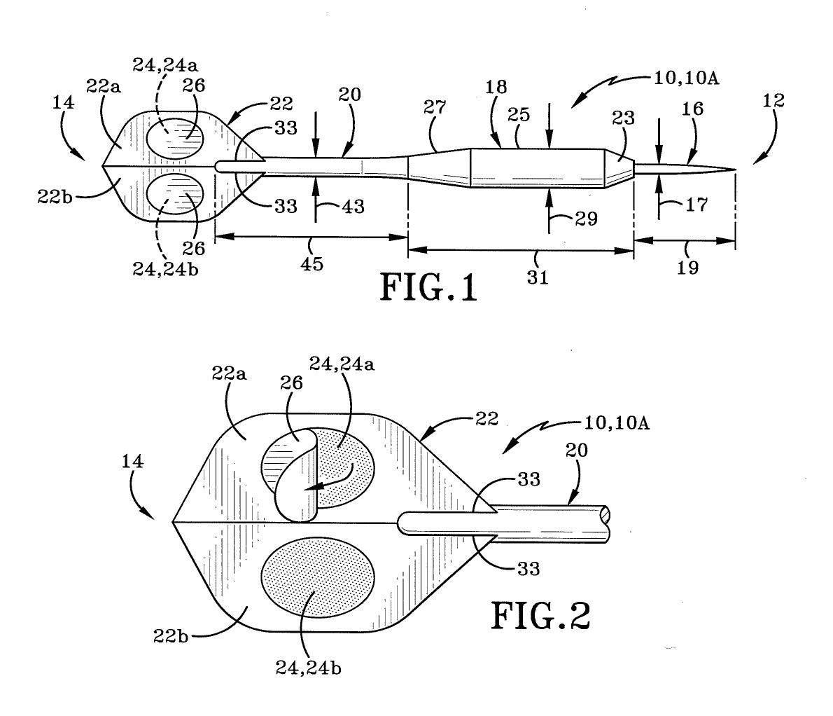

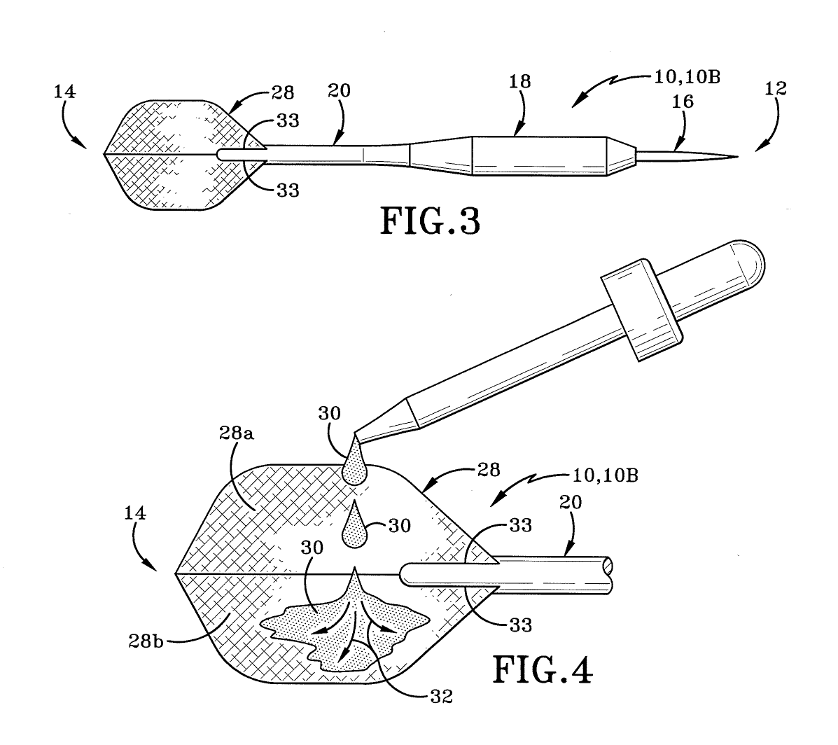

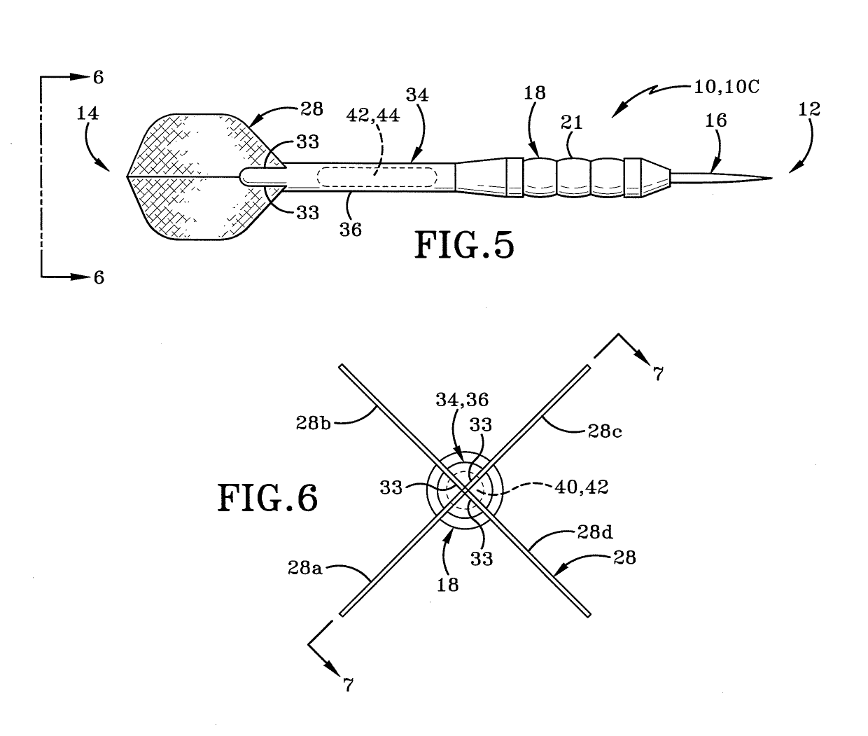

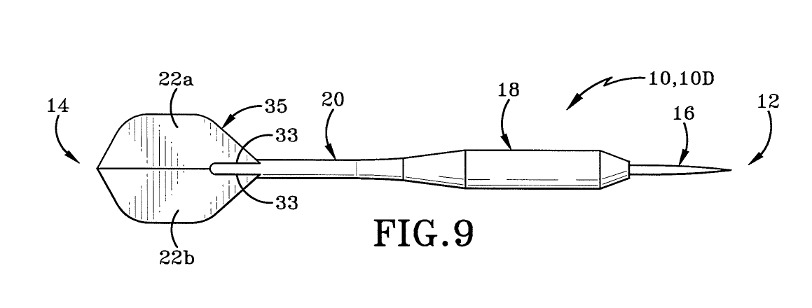

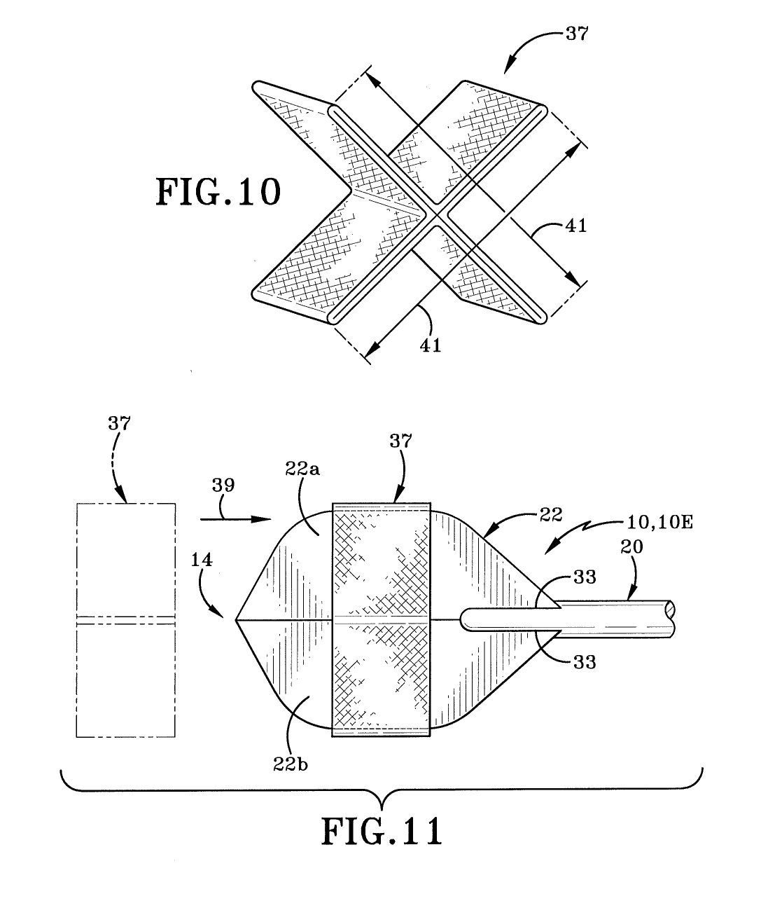

As depicted throughout the figures, a scented dart in accordance with the present disclosure is generally indicated at 10. One embodiment of the scented dart is depicted in FIG. 1 and FIG. 2 as 10A. A second embodiment of the scented dart is depicted in FIG. 3 and FIG. 4 as 10B. A third embodiment of the scented dart is depicted in FIG. 5 through FIG. 8 as 10C. A fourth embodiment of the scented dart is depicted in FIG. 9 as 10D. A fifth embodiment of the scented dart is depicted in FIG. 10 through FIG. 11 as 10E.

Each dart may include a first end 12 spaced opposite a second end 14 defining a longitudinal axis therebetween. Each dart may also include a tip 16, a barrel 18, a stem or shaft 20, and a flight 22.

The tip 16 is aligned with the longitudinal axis and is positioned at the leading end of the dart 10 such that the tip 16 defines the first end 12. In one particular embodiment, the tip 16 may have a sharpened end fabricated from steel or other metal. Tip 16 is rigidly connected with barrel 18. In one particular embodiment, tip 16 may be permanently fixed to barrel 18 extending towards the first end therefrom. In other embodiments, it is entirely possible for tip 16 to be threadably attached with barrel 18 in order to effectuate a removable connection between tip 16 barrel 18. In the event the tip 16 is made removable, the dart 10 may be customized with replacement steel tips 16 of varying length as one having ordinary skill in the art would understand and foresee. Additionally, it is not intended to be limiting that tip 16 be fabricated from metal and it is entirely possible that plastic-based soft tips may be utilized instead.

The tip 16 has a diameter 17 that is generally uniform along the longitudinal length 19 of tip 16. In one embodiment, the diameter 17 of tip 16 may be in a range from about 1 mm to about 5 mm. In another particular embodiment, the diameter 17 of tip 16 may be about 2.5 mm. The longitudinal length 19 is measured from the first end 12 to the connection of tip 16 with barrel 18. Longitudinal length 19 may be in a range from about 25 mm to about 35 mm. In one particular embodiment, the longitudinal length 19 of tip 16 may be in a range from 28 mm to 32 mm. The longitudinal length 19 of tip 16 may also be referred to herein as a first length.

The barrel 18 is a generally cylindrical member aligned with the longitudinal axis and is positioned farther away from the first end relative to tip 16. Typically, the barrel 18 may be in the form of a cylindrical shape, or a torpedo shape having tapered first and second ends, as indicated in FIG. 1. The outer surface of the barrel 18 may be covered with knurling or rings 21 to provide grip for the operator. Alternatively, barrel 18 may include a smooth outer surface in order to reduce drag as dart 10 moves through the air. Barrel 18 is preferably fabricated from metal in order to provide more mass to the overall dart. Additionally, the mass associated with barrel 18 is positioned closely adjacent forward end 12 such that the center of gravity is offset relative to the midline between first end 12 and second end 14. The metal utilized to fabricate barrel 18 may be any known variety, however a non-limiting and exemplary barrel 18 material is nickel-tungsten. Tungsten is a very dense metal which enables the dart 10 to be made with considerable mass and weight while still remaining relatively slim. Alternatively, barrel 18 may be fabricated from brass. Brass may provide sufficient weight for dart 10 but is a less expensive metal to fabricate with. Typically, the mass of barrel 18 is in a range from about 10 grams to about 40 grams. In some embodiments, the mass of barrel 18 may be in a range from about 14 grams to about 30 grams. The center of mass is offset towards the first end 12 relative to the midline between first end 12 and second end 14.

The barrel 18 may include a forward tapered section 23, a central cylindrical section 25, and a rearward tapered section 27. The central cylindrical section 25 of barrel 18 may have a diameter 29 that is greater than the diameter 17 of tip 16. The diameter 29 of the central cylindrical section 25 of barrel 18 may be in a range from about 7 mm to about 20 mm. A length 31 of the barrel 18 is measured from the forward end of forward tapered section 23 to the rear end of rearward tapered section 27. The longitudinal length 31 of barrel 18 may be in a range from about 25 mm to about 45 mm. As sometimes used herein, the diameter 29 of barrel 18 may sometimes be referred to as a second diameter, and similarly, the length 31 of barrel 18 may sometimes be referred to as a second diameter 31.

A ratio of the second diameter 29 to the first diameter 17 may be in a range from about 7:5 to about 20:1. A ratio of the second length 31 to the first length 19 may be in a range from about 0.5:1 to about 2:1. In one particular embodiment the ration of the second length 31 to the first length 1:1. These aforementioned ratios may prove critical in establishing the size of the hand thrown dart in order to emphasize its manual delivery, not a shot delivery initiated by a bow.

Shaft 20 may come in variety of lengths, materials, and colors. In some implementations, shaft 20 is fabricated from nylon in order to reduce the mass of the dart close to second end 14 to assist with the dart's weight balance being positioned towards the forward first end 12. In other instances, shaft 20 may be fabricated from an aluminum metal which may be more expensive than nylon, but has the ability to last longer.

Shaft 20 is a generally cylindrical member including a leading first end and a trailing second end. The leading first end of shaft 20 may be rigidly secured to the trailing second end of barrel 18. In some implementations, a threaded connection may establish a removable connection of shaft 20 relative to barrel 18. The trailing second end of shaft 20 may define longitudinally extending slots 33 configured to slidably receive flight 22 therein. The slots are formed orthogonally relative to each other such that four sections of flight 22 define four 90° angles (see FIG. 6). Shaft 20 has a third diameter 43 and a third length 45. The third length 45 is measured from the rear end of shaft 20 defining slots 33 to a forward portion of shaft 20 connected with section 27.

As depicted in FIG. 2 and in accordance with an aspect of the present disclosure, flight 22 carries a scented fluid or scented material 24 thereon. Scented material 24 may be permanently adhered to one or more of the four sections of flight 22. In the first embodiment dart 10A, a first scented material patch 24a is permanently adhered to first section 22a of flight 22. Additionally, a second section 22b of flight 22 is positioned orthogonal relative to a first section 22a of flight 22. Third flight (not shown) is substantially coplanar with first section 22a of flight 22. A fourth section (not shown) is coplanar to second section 22b and orthogonal to the third section to form four 90° angles at their respective intersections. Second section 22b carries a second scented material patch 24b. The second scented material patch 24b is permanently adhered to second section 22b. While conventional adhesion are utilized to attach second scented material patch 24b to second section 22c of flight 22, other known connecting means are entirely possible such as mechanical or other non-chemical and non-mechanical connecting means. Additionally, the third and fourth sections of flight 22 may have similar scented material patches attached thereto.

Each of the scented material patches 24a, 24b may be covered with a releasable sheet of material configured to be pulled by an operator when desiring to release the scent carried by first scented material patch 24a or second scented material patch 24b. The peelable sheet material may include a low-tack adhesive on the side of the material that engages the scented material 24 and the outer surface of sheet material 26 may be essentially adhesive free.

As indicated in FIG. 2, when the sheet material 26 is pulled away from the scented material 24, the scented material is exposed to the open air. With the scented material 24 exposed to the open air, its scent may be carried by the wind to a downwind destination. In some implementations in accordance with the present disclosure, the dart 10 may be used in hunting scenarios where it is advantageous to strategically place a scent upwind from an animal, such as a male deer, in order to attract the deer thereto.

In keeping with this embodiment of a hunting scenario, the scented material 24 may carry the scent of a female deer. It is well known that synthetic female deer urine is attractive to male deer. Ordinarily, deer urine is used by hunters to attract male deer in certain areas or locations in hunting environments. It is clearly advantageous to the hunter to bring the deer closer to the hunter rather than the hunter stalking the deer. Alternatively, scented material 24 may have an odor that replicates a food source, such as corn, apples, or the like.

The scented material 24 in the form of deer urine may be artificial or natural deer urine. Natural deer urine may be collected from a deer specimen as one having ordinary skill in the art would understand. Synthetic deer urine may be fabricated in the laboratory consisting essentially of urea and ammonia.

In the first embodiment 10A, the sections of flight 22 may be fabricated from a non-porous material such as plastic as one having ordinary skill in the art would understand and are generally rigid such that they retain their shape after being flexibly compressed. To the contrary, the scented material patches may be substantially porous in order to retain the scented fluid beneath the sheet membrane 26 prior to the sheet membrane being peeled off at the selected time being advantageous to the hunter. As will be described in greater detail below, other embodiments may provide alternative types of flights that may be substantially porous and capable of retaining fluid directly thereon.

As depicted in FIG. 3 and FIG. 4, the second embodiment 10B of the dart in accordance with the present disclosure includes a similar tip 16, barrel 18, and shaft 20 as that of the first embodiment 10A. The second embodiment dart 10B includes a flight 28 defining the second end 14 that is slidably attached to shaft 20. Flight 28 includes a first section 28a, a second section 28b, a third section (not shown), and fourth section (not shown). The first section 28a and the third section are aligned generally vertical and are coplanar. The second section 28b and the fourth section are aligned generally horizontal and coplanar. They intersect the first and third sections orthogonally to define perpendicular angles therebetween as one having ordinary skill in the art would understand and foresee.

Flight 28 is fabricated from a porous or sponge-like material capable of absorbing a fluid. One feature of flight 28 is that once a fluid saturates flight 28, flight sections retain their generally planar shape and do not deform when saturated with fluid. This provides advantage of enabling the flight 28 to still guide dart 10B as it is thrown while carrying scented fluid 30 within the porous material forming the respective flight sections.

As indicated in FIG. 4, the scented fluid 30 may be either dropped with a medicine dropper onto flight 28 or alternatively, and not shown but easily understood, the flight 28 may be dipped into a container of fluid 30. When scented fluid 30 contacts the porous material forming flight 28, it spreads as indicated by arrows 32 to substantially saturate each flight section of the entire flight 28. After the porous and sponge-like flight 28 has been fully saturated, or at least substantially saturated, the hunter may throw the dart 10B in a desired direction, preferably upwind from a male deer that is downwind from the dart 10B to draw the male deer towards the hunter.

As depicted in FIG. 5 through FIG. 8, the third embodiment dart 100 is provided with some similar components to that of first embodiment dart 10A and second embodiment dart 10B. The third embodiment dart 100 includes a shaft 34 that is a generally cylindrical member having an outer surface 36 and an inner surface 38 defining a cavity 40 therein. A crushable vial 42 is disposed within cavity 40. The crushable vial 42 may be filled with a scented fluid such as deer urine or a synthetic deer urine. The scented fluid of dart 100 is generally indicated at 44. Scented fluid 44 may further have an odor replicating a food source, such as apples, corn, or the like.

As depicted in FIG. 6, the orthogonal relationship between the flight sections is provided generally indicating that 90° angles are formed therebetween.

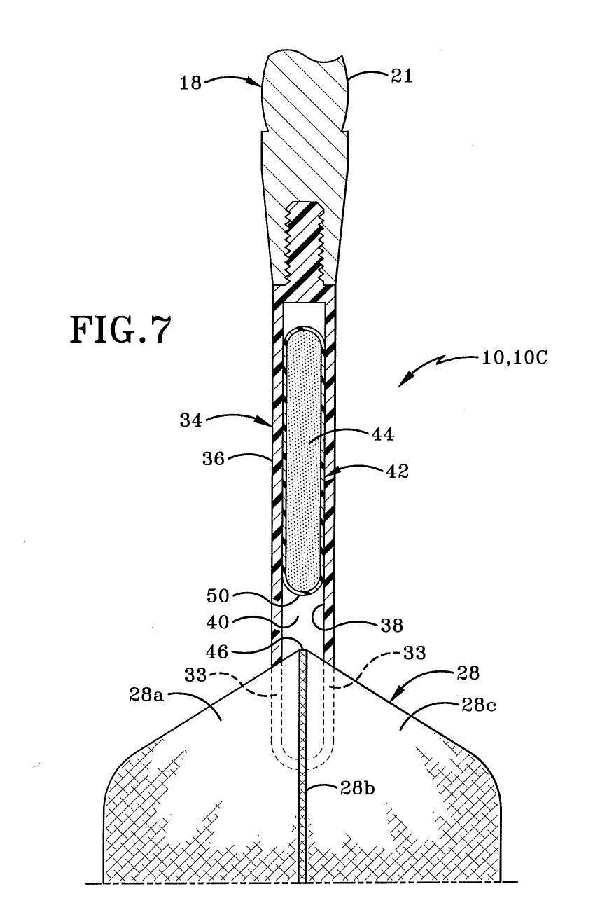

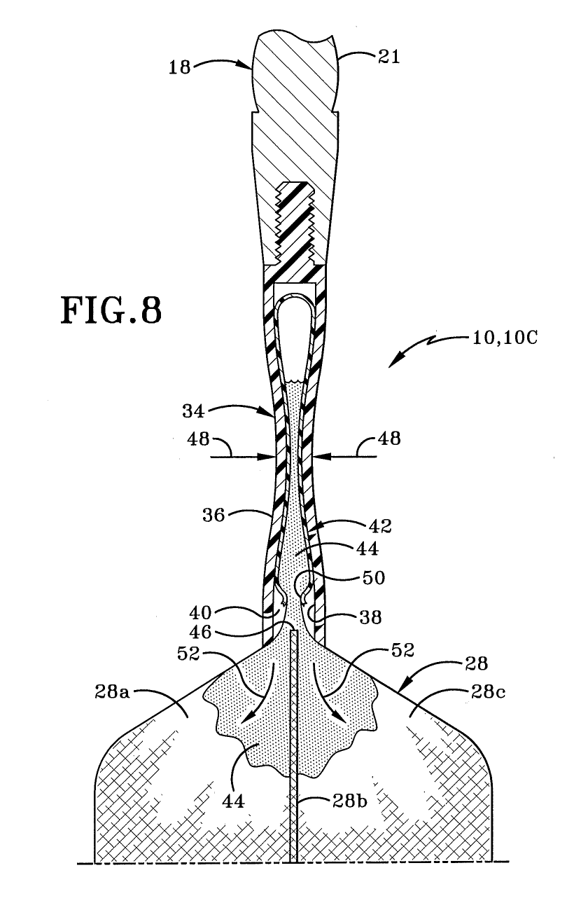

As depicted in the cross section views of FIG. 7 and FIG. 8, the vial 42 is positioned intermediate barrel 18 and flight 28 within cavity 40. The leading edge 46 of flight 28 is disposed internally within cavity 40 and is configured closely adjacent the trailing end of vial 42.

As indicated in FIG. 8, the sidewall of shaft 34 may be flexibly pinched in the direction of arrows 48 inwardly towards each other in order to crush vial 42. As vial 42 is crushed, the trailing end 50 ruptures, releasing fluid 44 in the direction of second end 14 towards flight 28. In one particular embodiment during the rupturing of vial 42, the hunter will hold the tip 16 substantially vertical with the tip 16 pointing upwardly such that tip 16 is positioned above the flight 28 enabling gravity to draw the scented fluid downwardly and saturate the four sections of flight 28 as indicated by arrows 52. The hunter may keep the third embodiment dart 10C in a substantially vertical alignment until all of the scented fluid 44 has drained outwardly from the vial and has been absorbed into the absorbent flight 28.

As depicted in FIG. 9, the fourth embodiment dart 10D is provided with similar components to that of the other dart embodiments. Similar features have not been repeated for brevity. Dart 10D may include flight 35 that is formed from plastic material having scent integrally formed therein. Flight 35 receives the desired scent during the manufacturing process as one having ordinary skill in the art would understand with respect to injecting scents into plastic injection molding and the like. Accordingly, a method of manufacture is established by the steps of providing an odorant designed to attract an animal; then, forming the flight 35 of the dart 10D with the odorant designed to attract the animal therein; then, providing the resultant flight 35 formed with scent to an end user for “in situ” assembly or to a dart manufacturer. The desired scent may replicate deer urine or a food source.

As depicted in FIG. 10 and FIG. 11, a fifth embodiment dart 10E provides that a slip cover 37 may be slidably received over the flight 22 at the rear end of dart 10E. Slip cover 37 may be formed in a variety of different manners however, one embodiment provides an X-shaped slip cover formed of a porous material. Stated otherwise, the slip cover 37 has a cross sectional shape complementary to the flight 22 to effectuate a slidable mating relationship therebetween. The porous material of slip cover 37 is configured to receive fluid 30 in a manner similar to that identified above with respect to FIG. 4. The slip cover 37 has a similar cross section to flight 22 that is sized to create a frictional interference fit when the slip cover 37 is slidably received over flight 22 in the direction of arrow 39 as indicated in FIG. 11.

Inasmuch as slip cover 37 fits over the flight 22, the diameter 41 of slip cover 37 is greater than the diameter of flight 22. Inasmuch as the diameter 41 of slip cover 37 is greater than the diameter of flight 22, diameter 41 of slip cover 37 is also greater than the first diameter 17 and the second diameter 29.

With continued reference to FIG. 11, flight 22 slidably fit within slots 33 formed in the rear end of shaft 20. The slot 33 is sized to receive flight 22 therein. Remarkably, the slots 33 are not equivalent and do not equate with a nock on a conventional arrow. Rather, it is to be understood that the narrow longitudinal slot 33 that receives flight 22 would be too small to fit a conventional bow string. Accordingly, it is to be understood that slot 33 should not be confused with the nock of an arrow.

In accordance with an aspect of one embodiment of the present disclosure, each of the embodiments provided herein of dart 10 enable a hunter to selectively throw and place a dart in the ground upwind from the suspected location of a deer. Preferably, the hand-thrown dart 10 is weighted in a manner that allows the hunter to accurately throw the dart 10 in a precise area. The hunter will know where to throw and place the dart relative to the wind direction in order to ensure that a deer senses the scented fluid, in this instance scented with female deer urine, rather than sensing the scent of the hunter. Alternatively, the scent of food could be utilized.

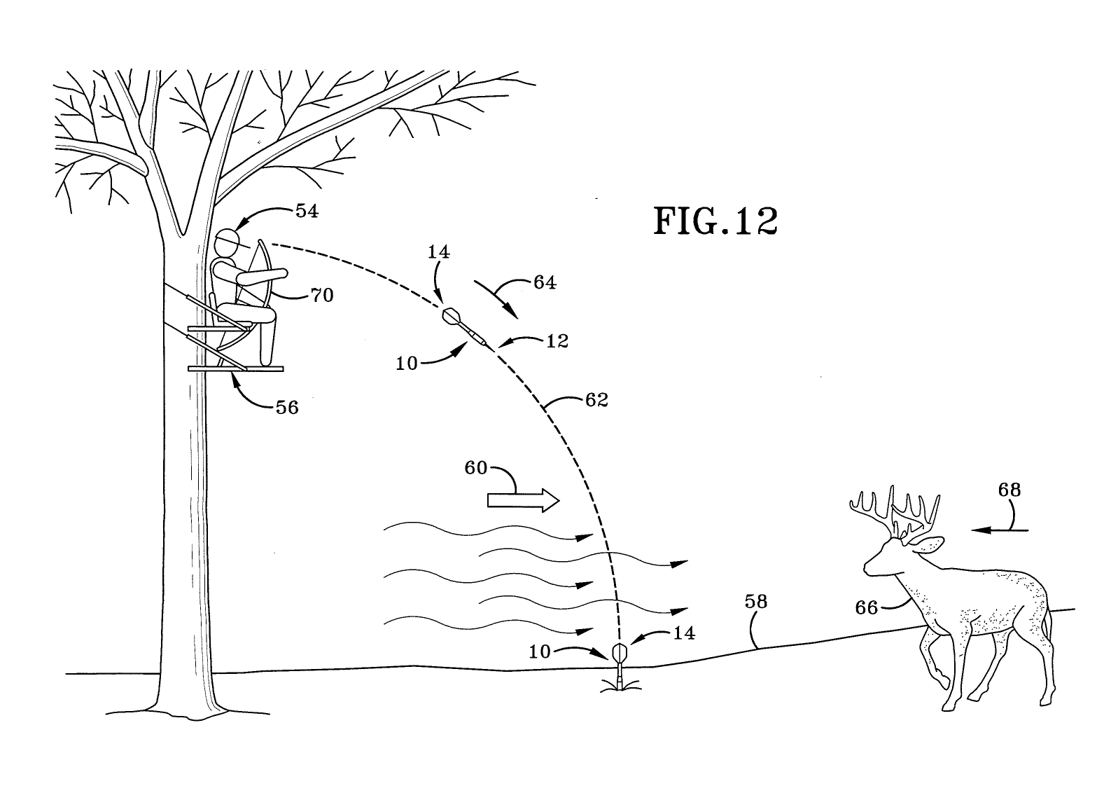

In operation and as depicted in FIG. 12, a hunter 54 is positioned in a tree stand 56 above the ground 58. The hunter may have any of the first, second, third, fourth, or fifth embodiment darts in the tree stand with him at a given time. For the purposes of FIG. 12, each of the five embodiments is generally indicated at 10, however it is entirely possible that any one of these would work in the following scenario. The hunter determines the wind direction which is represented by arrow 60. Once the wind direction has been determined, the hunter may release the scent into the air. To do so with the first embodiment dart 10A, the hunter 54 will peel away the sheet material 26 to provide an open air communication of the scented material 24 with the wind 60. To do so with the second embodiment dart 10B, the hunter 54 will drop the scented fluid 30 onto the absorbent flight 28. To do so with the third embodiment dart 100, the hunter will crush vial 42 to thereby release scented fluid 44 onto absorbent flight 28. To do so with the fourth embodiment dart 10D, the hunter will expose the scented flight 35 formed of plastic having the odorant scent integrally formed therewith to air. One version of the fourth embodiment dart 10D could provide a peelable cover, similar to that of cover 26 to wrap and seal the entire flight 35. To do so with the fifth embodiment dart 10E, the hunter will put fluid 30 onto the X-shaped slip cover 37 in a manner similar to that shown in FIG. 4.

Once the scent has been released into the air, the hunter will throw with their hand the dart 10 along an arcuate flight path 62 in the direction of arrow 64.

The dart 10 travels from the tree stand 56 as it is thrown by the hunter 54 and lands and then plants itself into ground 58 such that the tip 16 is pointed downwardly and impaled into ground 58. Dart 10 is weighted in a manner such that the tip 16 is positioned and stuck into the ground 58 but the second end 14 is positioned above ground 58. When the second end 14 is positioned above ground 58, the wind direction movement is able to carry the scent contained and released from the flight 28 defining the second end 14 in the downwind direction 60. As the scent is carried by the wind in the direction of the downwind arrow 60, a deer 66 may be drawn from the downwind direction towards the tree stand 56 as indicated by the deer 66 movement arrow 68. As the deer 66 begins to walk upwind towards the tree stand 56, the hunter may utilize a weapon, such as a bow 70 or rifle (not shown), to terminate the life of the deer 66 (i.e., kill the deer).

While it is preferable that the dart 10 is hand thrown and not launched utilizing bow 70, there may be some implementations that could fabricate an attachment mechanism that would enable the hunter 54 to shoot dart 10 with bow 70.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A scented throwing dart used as a hunting aide comprising:
a tip;
a barrel connected to the tip; and
a flight that carries a scent configured to attract a game animal;
wherein the throwing dart is adapted to be manually thrown from a tree stand by a hunter in order for the scent to be carried downwind to attract the game animal from a remote location towards the hunter in the tree stand.

2. The scented throwing dart of claim 1, further comprising:
a shaft connected to the barrel opposite the tip, wherein the shaft defines a slot in a rear end that slidably receives the flight.

3. The scented throwing dart of claim 2, wherein the scent is at least partially rearward from the slot.

4. The scented throwing dart of claim 2, wherein the flight is formed from a uniform polymer material having the scent integrally formed therein.

5. The scented throwing dart of claim 2, wherein the flight is formed from a solid material carrying a scented patch having a selectively peelable cover configured to selectively release the scent when the cover has been peeled.

6. The scented throwing dart of claim 2, wherein the flight is formed from a porous material configured to hold the scent in fluid form.

7. The scented throwing dart of claim 2, further comprising:
a slip cover covering the flight, wherein the scent is carried by the slip cover.

8. The scented throwing dart of claim 7, wherein the slip cover has a cross section shape complementary to the flight to effectuate a slidable mating relationship therebetween.

9. The scented throwing dart of claim 1, further comprising:
a first diameter of the tip;
a second diameter of the barrel, wherein the second diameter is larger than the first diameter; and
a ratio of the second diameter to the first diameter that is in a range from about 7:5 to about 20:1.

10. The scented throwing dart of claim 1, further comprising:
a first length of the tip;
a second length of the barrel;
a ratio of the second length to the first length that is in a range from about 0.5:1 to about 2:1.

11. A method of attracting a game animal to be hunted comprising:
providing a dart for use as a hunting aide that is sized and shaped to be hand thrown comprising an animal attracting scent or odor carried by a flight defining a tail end of the dart rearward from a shaft; and
hand throwing the dart into a ground surface so at to establish the dart in-ground position wherein a tip is embedded in the ground and the flight sticks upwardly above the ground.

12. The method of claim 11 wherein step of hand throwing the dart is accomplished by throwing the dart from an elevated position towards the ground.

13. The method of claim 11, further comprising:
placing scent near the ground adapted to enable a hunter to remain in a tree stand without interrupting the scent effectuating attraction of an animal towards the flight.

14. The method of claim 11, wherein hand throwing the dart is accomplished by grasping a barrel of the dart having a diameter larger than a tip of the dart, wherein a ratio of barrel diameter to tip diameter is in a range from about 7:5 to about 20:1.

15. The method of claim 11, further comprising peeling a releasably cover away from the flight to expose the scent.

16. The method of claim 11, further comprising dipping the flight into scented fluid, wherein the flight is porous configured to absorb and carry the scented fluid as the dart is hand thrown.

17. The method of claim 11, further comprising adding scented fluid to the flight, wherein the flight are porous configured to absorb and carry the scented fluid as the dart is hand thrown.

18. The method of claim 17, further comprising breaking a vial containing the scented fluid and effecting fluid transfer from the vial to the porous flight.

19. The method of claim 11, wherein the flight is fabricated from a uniform polymer material integrally formed with the scent or odor.

20. A dart for use as a hunting aid that is sized and shaped to be hand thrown comprising an animal attracting scent or odor carried by a flight defining a tail end of the dart rearward from a shaft.
